(19) United States
(12) Patent Application Publication
(10) Pub. No.: US 2026/0365865 A1
(43) Pub. Date: Nov. 19, 2026

(54) WATER-BASED INK

(71) Applicant: Byoung Chan LEE, Yongin-si, Gyeonggi-do (KR)

(72) Inventors: Byoung Chan LEE, Yongin-si, Gyeonggi-do (KR); Kwang Mo LEE, Yongin-si, Gyeonggi-do (KR); In Hee CHOI, Uiwang-si, Gyeonggi-do (KR); Hae Young LEE, Hwaseong-si, Gyeonggi-do (KR)

(73) Assignee: Byoung Chan LEE, Yongin-si, Gyeonggi-do (KR)

(21) Appl. No.: 19/132,373

(22) PCT Filed: Nov. 30, 2023
(86) PCT No.: PCT/KR2023/019537

§ 371 Date: May 23, 2025

(30) Foreign Application Priority Data
Dec. 1, 2022 (KR) 10-2022-0165498
Dec. 1, 2022 (KR) 10-2022-0165513
Dec. 1, 2022 (KR) 10-2022-0165531
Dec. 1, 2022 (KR) 10-2022-0165556

(51) Int. Cl. C09D 11/102; C09D 11/037

(52) U.S. Cl. CPC C09D 11/102; C09D 11/037

(57) ABSTRACT

The water-based ink of the present invention is characterized by comprising a synthetic resin, water, ethanol, an antifoaming agent, a wetting agent, a dispersant, and a pigment, wherein the synthetic resin is aqueous urethane and aqueous acrylic, comprises a composition having a ratio of 12.5 to 30 wt. % of the aqueous urethane, 5 to 10 wt. % of the aqueous acrylic, 20 to 37.5 wt. % of the water, 10 to 20 wt. % of the ethanol, 0.1 to 0.5 wt. % of the antifoaming agent, 0.1 to 0.5 wt. % of the wetting agent, 2 to 4 wt. % of the dispersant, and 10 to 15 wt. % of the pigment, and is for flexographic printing on the surface of PP film..

### TECHNICAL FIELD

The present invention relates to a water-based ink.

### BACKGROUND ART

Flexographic printing is a method of printing on fabric by applying ink to an anilox roller and then transferring the ink to a convexly engraved resin plate. Flexographic printing has many advantages over other printing methods, especially gravure printing, such as the simple production of plates, low cost, and the ability to partially replace plates due to easy duplication of plates, and is suitable for printing small lots due to its economic efficiency, and thus it is used on a variety of materials. For example, a printing layer can be formed on materials such as PE, PP, PVC, and PS using the flexographic technique.

Meanwhile, polypropylene (PP) is a crystalline plastic belonging to the polyolefin series and is a fabric that does not absorb water, and it is used for thin sheets for packaging, pipe joints, household goods, etc. In flexographic printing on such PP films, it currently uses a method of dissolving and printing with oil-based ink containing a strong solvent, which is a hazardous chemical substance. However, unlike other films, the ink printed on PP is directly exposed to the outside, so the residual solvent of the ink has a significant impact on the environment and the human body. Therefore, there is a need for a technology that allows printing and adhesion without dissolving the PP film and without the need for hazardous chemical substances.

Gravure printing is a method of applying ink to a copper plate for printing engraved in a concave shape, removing ink from areas other than the concave area with a doctor's knife, and printing the ink contained in the concave area onto the film. Gravure printing has the advantage of being suitable for mass printing because it allows for high-speed printing and has excellent reproducibility of fonts, letters, and designs. For example, a printing layer can be formed on packaging films such as PVC, PE, OPP, PET, and NYLON films using the gravure technique. This gravure printing is an industry that uses a large amount of organic solvents, which are hazardous chemical substances, and the situation surrounding the gravure printing industry is becoming increasingly stricter, with regulations such as the Hydrocarbon Emission Regulations, Fire Protection Act, Industrial Safety and Health Act, and Chemical Substances Control Act. In this situation, domestically and internationally, each law is being strengthened to regulate or even prohibit the use of hazardous chemical substances.

The ink used for printing on PVC has excellent adhesive force and can be thermally laminated, has excellent friction resistance, no bad odor, and has excellent light resistance and durability, and thus is used in various ways, such as for interior and floor reform sheets. In the past, when performing gravure printing on PVC, it was common to print by dissolving PVC with oil-based ink containing a strong solvent, which is a hazardous chemical substance. However, this method has a problem in that residual solvent remains after printing, which is harmful to the environment and human body. Therefore, in gravure printing of PVC, there is a need for a technology that prints and bonds PVC fabric without melting it and without hazardous chemical substances.

Screen printing is a printing method that prints a target printing pattern by extruding printing materials such as ink or paste through the opening of a screen-printing plate by the contacting and moving action of a squeeze, and transferring the shape of the opening to the object to be printed. Screen printing is used in many industries because of its high productivity, and today it is widely used in electronic products such as mobile phones, keypads, PDPs, and LCDs. Nozzle printer printing is a printing method that prints the results of computer work by spraying ink through a nozzle using a printer.

Meanwhile, for fibers such as cotton or silk, various designs can be printed using gravure printing, screen printing, and nozzle printer printing, but the most important factor in printing such fibers is fastness properties to friction, washing, and color.

Currently, there is no water-based ink that satisfies the fastness property, which is an important factor in printing such fibers, and is adhesive (printable). Oil-based ink is used as industrial ink for printing textiles. Therefore, there is a need for a water-based ink that satisfies the fastness property and is adhesive (printable).

### DISCLOSURE

### Technical Problem

It is an object of the present invention to provide a water-based ink that is capable of flexographic printing without dissolving PP film and without hazardous chemical substances, is adhesive to print media and has high water resistance.

In addition, it is another object of the present invention to provide a water-based ink that can be gravure printed without dissolving PVC and without hazardous chemical substances and that adheres to print media.

In addition, it is another object of the present invention to provide a water-based ink for textiles that can be clearly printed on textiles and has excellent fastness properties.

In addition, it is another object of the present invention to provide ink that can be printed on fiber in various ways, and the printing method can be gravure printing, screen printing, nozzle printer printing, etc.

In addition, it is another object of the present invention to provide a water-based ink that can be gravure printed without dissolving shrink film and without hazardous chemical substances, and that adheres to print media.

### Technical Solution

The water-based ink according to one embodiment of the present invention may comprise a synthetic resin, water, ethanol, an antifoaming agent, a wetting agent, a dispersant, and a pigment.

In one embodiment, the synthetic resin is aqueous urethane and aqueous acrylic and contains a composition having a ratio of 12.5 to 30 wt. % of the aqueous urethane, 5 to 10 wt. % of the aqueous acrylic, 20 to 37.5 wt. % of the water, 10 to 20 wt. % of the ethanol, 0.1 to 0.5 wt. % of the antifoaming agent, 0.1 to 0.5 wt. % of the wetting agent, 2 to 4 wt. % of the dispersant, and 10 to 15 wt. % of the pigment, and the water-based ink may be for flexographic printing on the surface of a PP film.

In one embodiment, the water-based ink further comprising wax, comprises a composition having a ratio of 30 to 40 wt. % of the synthetic resin, 17 to 46.8 wt. % of the water, 10 to 20 wt. % of the ethanol, 0.1 to 0.5 wt. % of the antifoaming agent, 0.1 to 0.5 wt. % of the wetting agent, 2 to 4 wt. % of the dispersant, 1 to 3 wt. % of the wax, and 10 to 15 wt. % of the pigment, wherein the synthetic resin contains aqueous epoxy, aqueous acrylic, and aqueous urethane, and may be for gravure printing on the surface of PVC.

In one embodiment, the water-based ink further comprising wax and a fastness enhancer, wherein the synthetic resin is aqueous urethane and aqueous acrylic, comprises a composition having a ratio of 15 to 20 wt. % of the aqueous urethane, 25 to 30 wt. % of the aqueous acrylic, 17 to 36.7% of the water, 10 to 20 wt. % of the ethanol, 0.1 to 0.5 wt. % of the antifoaming agent, 0.1 to 0.5 wt. % of the wetting agent, 2 to 4 wt. % of the dispersant, 1 to 3 wt. % of the wax, 10 to 15 wt. % of the pigment, and 0.1 to 1 wt. % of the fastness enhancer, and can be used for textiles.

In one embodiment, the water-based ink further comprising a slip agent, wherein the synthetic resin is aqueous urethane and aqueous acrylic, comprises a composition having a ratio of 10 to 15 wt. % of the aqueous urethane, 10 to 25 wt. % of the aqueous acrylic, 19.5 to 47 wt. % of the water, 10 to 20 wt. % of the ethanol, 0.1 to 0.5 wt. % of the antifoaming agent, 0.1 to 0.5 wt. % of the wetting agent, 2 to 4 wt. % of the dispersant, 10 to 15 wt. % of the pigment, and 0.1 to 0.5 wt. % of the slip agent, and can be used for shrink film.

In one embodiment, the pigment may contain at least one of an inorganic pigment and an organic pigment.

In one embodiment, the wax may contain polyethylene.

In one embodiment, the fastness enhancer may contain at least one of a silane group and an alkyl group.

In one embodiment, the pigment may contain aluminum.

### Advantageous Effects

The water-based ink of the present invention can be used for flexographic printing without dissolving PP film and without hazardous chemical substances, adheres to print media, and has high water resistance.

In addition, the water-based ink of the present invention can be used for gravure printing without dissolving PVC fabric and without hazardous chemical substances, and can be adhered to print media.

In addition, the present invention can provide a water-based ink for textiles that enables clear printing on textiles and has excellent fastness properties.

In addition, the water-based ink of the present invention can be gravure printed without dissolving shrink film and without hazardous chemical substances, and can be adhered to print media.

The effects of the present invention are not limited to the effects mentioned above, and other effects not mentioned will be clearly understood by those skilled in the art from the description below.

### DESCRIPTION OF DRAWINGS

FIG. 1 is a flow chart illustrating a method for preparing water-based ink for flexographic printing according to an embodiment of the present invention.

FIG. 2 is a flow chart illustrating a method for preparing water-based ink for gravure printing according to an embodiment of the present invention.

FIG. 3 is a flow chart illustrating a method for preparing water-based ink for textiles according to an embodiment of the present invention.

FIG. 4 is a flow chart illustrating a method for preparing water-based ink for shrink film according to an embodiment of the present invention.

### BEST MODE

Hereinafter, preferred embodiments of the present invention will be described with reference to the accompanying drawings. However, the embodiments of the present invention may be modified in various other forms, and the scope of the present invention is not limited to the embodiments described below. In addition, the embodiments of the present invention are provided to more completely explain the present invention to those with average knowledge in the art. Accordingly, the shape and size of elements in the drawings may be exaggerated for clearer explanation, and elements indicated by the same symbol in the drawings are the same elements.

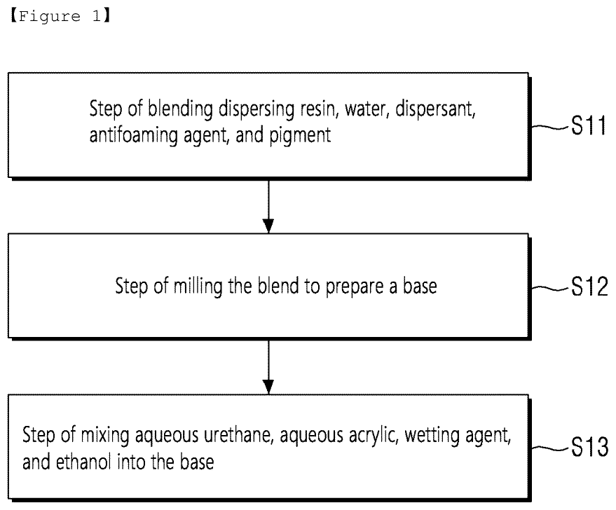

FIG. 1 is a flow chart illustrating a method for preparing water-based ink for flexographic printing according to an embodiment of the present invention.

Referring to FIG. 1, it relates to a method for preparing water-based ink for flexographic printing on a polypropylene (PP) film. The preparation method comprises a blending step, a dispersion step, and a mixing step. The water-based ink comprises a composition composed of an aqueous urethane, an aqueous acrylic, water, ethanol, an antifoaming agent, a wetting agent, a dispersant, and a pigment, and may further comprise a dispersing resin.

The aqueous urethane is a component that maintains adhesiveness when printed on a film, and in a preferred embodiment of the present invention, it is contained in a component ratio of 12.5 to 30 wt. %.

The aqueous acrylic plays a role in allowing the water-based ink to adhere to the film, and may contain an acrylic monomer such as acrylic acid or methyl methacrylate. In a preferred embodiment of the present invention, the aqueous acrylic is contained in a component ratio of 5 to 10 wt. %.

Meanwhile, the aqueous urethane and aqueous acrylic play a role in allowing the ink to adhere to the fabric and improving the water resistance. Therefore, if the component ratio of the aqueous urethane and aqueous acrylic is not appropriate, the adhesive strength and water resistance may be reduced. For example, if the aqueous acrylic is more than the appropriate ratio, the water resistance of the ink is reduced.

Water is used as a solvent for other components, and can be used by appropriately adjusting the component ratio within the range of 20 to 37.5 wt. %.

Ethanol plays a role in increasing the productivity of printing by accelerating the drying speed during printing. The ethanol is used as a solvent in ink, and unlike conventional solvents such as toluene, it is not a toxic substance. The Ethanol has the advantage of not remaining on the packaging and volatilizing as it dries during the printing process. In a preferred embodiment of the present invention, the ethanol is contained in a component ratio of 10 to 20 wt. %.

The antifoaming agent prevents the formation of bubbles due to water during the dispersion process described later, thereby enabling smooth dispersion. In addition, the antifoaming agent prevents bubbles from appearing in the printed matter, thereby enabling accurate printing. In a preferred embodiment of the present invention, the antifoaming agent is contained in a component ratio of 0.1 to 0.5 wt. %.

The wetting agent plays a role in preventing re-aggregation of pigment and helping accurate printing. In a preferred embodiment of the present invention, the wetting agent is contained in a component ratio of 0.1 to 0.5 wt. %.

The dispersant disperses the pigment, and thus plays a role in preventing re-aggregation of the pigment and maintaining dispersibility. In a preferred embodiment of the present invention, the dispersant is contained in a component ratio of 2 to 4 wt. %.

The pigment is a component that performs the coloring role of the water-based ink, and any pigment commonly used in the art can be used. Specifically, inorganic pigments such as carbon black and metal oxides and organic pigments such as azo pigments, diazo pigments, phthalocyanine pigments, perylene pigments, perinone pigments, thioindigo pigments, anthraquinone pigments, and quinophthalone pigments can be used. Since the pigment is exposed to sunlight, in a preferred embodiment of the present invention, a pigment having high light resistance is used as the pigment, and more specifically, it is preferred to use a pigment having a light resistance of grade 7 or higher. In a preferred embodiment of the present invention, the pigment is contained in a composition ratio of 10 to 15 wt. %.

The water-based ink according to one embodiment of the present invention can control the darkness and lightness of the color of the ink depending on the amount of pigment contained, and the pigment can be controlled within a range of 10 to 15 wt. % depending on the required color.

The water-based ink comprising a composition having the ratio as described above and a preparation method thereof are as follows.

It comprises a blending step (S11) of blending the dispersing resin, water, the dispersant, the antifoaming agent, and the pigment, a dispersing step (S12) of dispersing the blend to prepare a base, and a mixing step (S13) of mixing the aqueous urethane, the aqueous acrylic, the wetting agent, and ethanol into the base.

In this case, the dispersing resin blended in step (S11) plays a role of chemically assisting the dispersion of the pigment in step (S12), and may contain an epoxy ester resin, a vinyl modified epoxy resin, a high acid value alkyd resin, a vinyl modified resin, etc.

More specifically, the chemical dispersion in the step (S12) is achieved by the dispersing resin and the dispersant, and the physical dispersion is achieved by milling using a bead mill. Here, milling refers to uniformly mixing and kneading the components by heat and mechanical action.

In this case, the component ratio of the components excluding the dispersing resin is 12.5 to 30 wt. % of the aqueous urethane, 5 to 10 wt. % of the aqueous acrylic, 20 to 37.5 wt. % of the water, 10 to 20 wt. % of the ethanol, 0.1 to 0.5 wt. % of the antifoaming agent, 0.1 to 0.5 wt. % of the wetting agent, 2 to 4 wt. % of the dispersant, and 10 to 15 wt. % of the pigment.

Hereinafter, the present invention will be described in more detail by way of examples. However, these examples are intended to exemplify the present invention, and the scope of the present invention is not limited by these examples.

### EXAMPLE 1

The dispersing resin, the water, the dispersant, the antifoaming agent, and the pigment were first blended, and the blend was dispersed to prepare a base, and then, the aqueous urethane, the aqueous acrylic, the wetting agent, and ethanol were mixed with the base to prepare a water-based ink. The component ratio of each component, excluding the dispersing resin, is as shown in the table below.

TABLE 1

| Component | wt. % |
|---|---|
| aqueous urethane | 25 |
| aqueous acrylic | 7 |
| water | 37 |
| ethanol | 15 |
| antifoaming agent | 0.5 |
| wetting agent | 0.5 |
| dispersant | 3 |
| pigment | 12 |

### EXAMPLE 2

A water-based ink was prepared in the same manner as in Example 1. The component ratio of each component is as shown in the table below.

TABLE 2

| Component | wt. % |
|---|---|
| aqueous urethane | 12.5 |
| aqueous acrylic | 10 |
| water | 37.5 |
| ethanol | 20 |
| antifoaming agent | 0.5 |
| wetting agent | 0.5 |
| dispersant | 4 |
| pigment | 15 |

### EXAMPLE 3

A water-based ink was prepared in the same manner as in Example 1. The component ratio of each component is as shown in the table below.

TABLE 3

| Component | wt. % |
|---|---|
| aqueous urethane | 27 |
| aqueous acrylic | 5 |
| water | 37 |
| ethanol | 15 |
| antifoaming agent | 0.5 |
| wetting agent | 0.5 |
| dispersant | 3 |
| pigment | 12 |

### EXAMPLE 4

A water-based ink was prepared in the same manner as in Example 1. The component ratio of each component is as shown in the table below.

TABLE 4

| Component | wt. % |
|---|---|
| aqueous urethane | 28 |
| aqueous acrylic | 7 |
| water | 37 |
| ethanol | 10 |
| antifoaming agent | 0.5 |
| wetting agent | 0.5 |
| dispersant | 3 |
| pigment | 14 |

### EXAMPLE 5

A water-based ink was prepared in the same manner as in Example 1. The component ratio of each component is as shown in the table below.

TABLE 5

| Component | wt. % |
|---|---|
| aqueous urethane | 25 |
| aqueous acrylic | 7 |
| water | 37.4 |
| ethanol | 15 |
| antifoaming agent | 0.1 |
| wetting agent | 0.5 |
| dispersant | 3 |
| pigment | 12 |

### EXAMPLE 6

A water-based ink was prepared in the same manner as in Example 1. The component ratio of each component is as shown in the table below.

TABLE 6

| Component | wt. % |
|---|---|
| aqueous urethane | 25 |
| aqueous acrylic | 7 |
| water | 37.4 |
| ethanol | 15 |
| antifoaming agent | 0.5 |
| wetting agent | 0.1 |
| dispersant | 3 |
| pigment | 12 |

### EXAMPLE 7

A water-based ink was prepared in the same manner as in Example 1. The component ratio of each component is as shown in the table below.

TABLE 7

| Component | wt. % |
|---|---|
| aqueous urethane | 25 |
| aqueous acrylic | 7 |
| water | 37 |
| ethanol | 15 |
| antifoaming agent | 0.5 |
| wetting agent | 0.5 |
| dispersant | 2 |
| pigment | 13 |

### EXAMPLE 8

A water-based ink was prepared in the same manner as in Example 1. The component ratio of each component is as shown in the table below.

TABLE 8

| Component | wt. % |
|---|---|
| aqueous urethane | 28 |
| aqueous acrylic | 7 |
| water | 37 |
| ethanol | 15 |
| antifoaming agent | 0.5 |
| wetting agent | 0.5 |
| dispersant | 2 |
| pigment | 10 |

### COMPARATIVE EXAMPLE 1

An ink was prepared by mixing a vinyl resin, a urethane resin, a pigment, and toluene. The component ratio of each component is as shown in the table below.

TABLE 9

| Component | wt. % |
|---|---|
| vinyl resin | 5 |
| urethane resin | 35 |
| pigment | 25 |
| toluene | 35 |

### EXPERIMENTAL EXAMPLE 1: RESIDUAL SOLVENT DETECTION TEST

The inks of Examples 1 to 8 and Comparative Example 1 were used to print on PP film and the presence or absence of residual solvent was confirmed.

TABLE 10

| | Example | Example | Example | Example | Example | Example | Example | Example | Comparative |
|---|---|---|---|---|---|---|---|---|---|
| | 1 | 2 | 3 | 4 | 5 | 6 | 7 | 8 | Example 1 |
| residual | not | not | not | not | not | not | not | not | detected |
| solvent | detected | detected | detected | detected | detected | detected | detected | detected | |

The test results showed that no residual solvent remained when printing with the water-based inks of Examples 1 to 8. The ink of Comparative Example 1 was found to leave residual solvent.

### EXPERIMENTAL EXAMPLE 2: DISSOLUTION TEST OF PP FILM

Using the inks of Examples 1 to 8 and Comparative Example 1, printing was performed on a PP film having a thickness of 0.04 mm, and the thickness of the PP film printing area was measured to confirm the extent to which the ink dissolved the PP film.

TABLE 11

| | Example | Example | Example | Example | Example | Example | Example | Example | Comparative |
|---|---|---|---|---|---|---|---|---|---|
| | 1 | 2 | 3 | 4 | 5 | 6 | 7 | 8 | Example 1 |
| Thickness | 0.04 | 0.04 | 0.04 | 0.04 | 0.04 | 0.04 | 0.04 | 0.04 | 0.032 |
| of PP | | | | | | | | | |
| film | | | | | | | | | |
| printing | | | | | | | | | |
| area (mm) | | | | | | | | | |

The test results showed that when printed with the water-based inks of Examples 1 to 8, the PP film printing area did not dissolve and thus the thickness was maintained. The ink of Comparative Example 1 was found to be printed while dissolving the PP film, as evidenced by the reduction in the thickness of the PP film printing area.

### EXPERIMENTAL EXAMPLE 3: WATER-RESISTANCE TEST

The inks of Examples 1 to 8 and Comparative Example 1 were applied with a thickness of about 200 μm on a PP film and dried at room temperature for about 24 hours to form a coating. Thereafter, the PP film was immersed in water, and after 30 minutes, whether the coating was soluble in water was observed with the naked eye. If the coating did not dissolve in water, it was evaluated as “good.”

TABLE 12

| | Example | Example | Example | Example | Example | Example | Example | Example | Comparative |
|---|---|---|---|---|---|---|---|---|---|
| | 1 | 2 | 3 | 4 | 5 | 6 | 7 | 8 | Example 1 |
| water- | good | good | good | good | good | good | good | good | good |
| resistance | | | | | | | | | |

The test results showed that both the water-based inks of Examples 1 to 8 and the ink of Comparative Example 1 had excellent water resistance because the coatings did not dissolve in water. As shown in Experimental Examples 1 and 2, it can be seen that in the case of ink containing a strong solvent such as toluene, it dissolves the PP film and is printed, and residual solvent remains after printing. As shown in Experimental Example 3 above, it can be seen that the water-based ink for PP film according to the present invention has excellent water resistance.

As such, the water-based ink of the present invention has excellent water resistance, is printed without dissolving the PP film, and leaves no residual solvent after printing, thereby resolving environmental and safety issues caused by an oil-based ink containing a strong solvent, which is a hazardous chemical substance, and thus is a useful ink that can replace the oil-based ink containing a strong solvent.

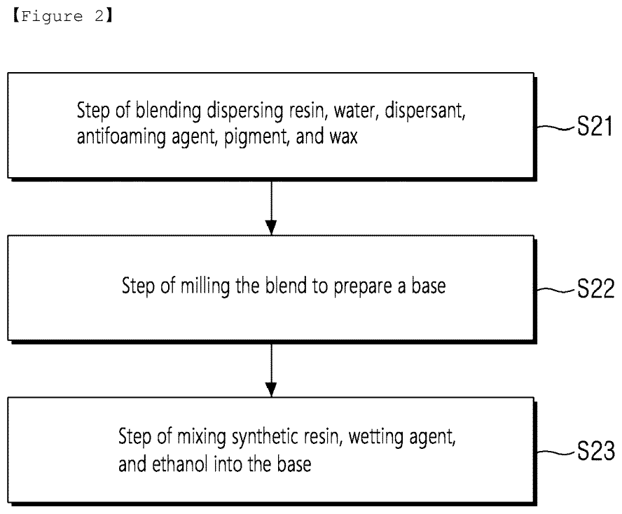

FIG. 2 is a flow chart illustrating a method for preparing water-based ink for gravure printing according to an embodiment of the present invention.

Referring to FIG. 2, the present invention relates to a water-based ink for gravure printing on the surface of PVC and a preparation method thereof. The preparation method comprises a blending step, a dispersion step, and a mixing step. The water-based ink comprises a composition composed of a synthetic resin, water, ethanol, an antifoaming agent, a wetting agent, a dispersant, wax, and a pigment, and may further comprise a dispersing resin.

The synthetic resin is a main material that enables ink to adhere to the fabric, and may contain an aqueous epoxy, an aqueous acrylic, or an aqueous urethane. In a preferred embodiment of the present invention, it is contained in a component ratio of 30 to 40 wt. %.

Water is used as a solvent for other components, and can be used by appropriately adjusting the component ratio within the range of 17 to 46.8 wt. %.

Ethanol is added to achieve quick drying properties, which are characteristic of ink. Ethanol is used as a solvent in ink, and unlike conventional solvents such as toluene, it is not a toxic substance and has the advantage of not remaining on the fabric and volatilizing as it dries during the printing process. In a preferred embodiment of the present invention, the ethanol is contained in a component ratio of 10 to 20 wt. %.

The antifoaming agent prevents the formation of bubbles due to water during the dispersion process described later, thereby enabling smooth dispersion. In addition, the antifoaming agent prevents bubbles from appearing in the printed matter, thereby enabling accurate printing. In a preferred embodiment of the present invention, the antifoaming agent is contained in a component ratio of 0.1 to 0.5 wt. %.

The wetting agent plays a role in preventing re-aggregation of pigment and helping accurate printing. In a preferred embodiment of the present invention, the wetting agent is contained in a component ratio of 0.1 to 0.5 wt. %.

The dispersant disperses the pigment, and thus plays a role in preventing aggregation of the pigment and maintaining dispersibility. In a preferred embodiment of the present invention, the dispersant is contained in a component ratio of 2 to 4 wt. %.

Wax plays a role in improving the adhesive strength of ink. In a preferred embodiment of the present invention, the wax contains polyethylene and is contained in a component ratio of 1 to 3 wt. %.

The pigment is a component that performs the coloring role of the water-based ink, and any pigment commonly used in the art can be used. Specifically, inorganic pigments such as carbon black and metal oxides and organic pigments such as azo pigments, diazo pigments, phthalocyanine pigments, perylene pigments, perinone pigments, thioindigo pigments, anthraquinone pigments, and quinophthalone pigments can be used. In a preferred embodiment of the present invention, a pigment having high light resistance and heat resistance is used as the pigment, and more specifically, it is preferred to use the pigment having a light resistance of grade 7 or higher and a heat resistance of 200 °C or more.

The water-based ink according to one embodiment of the present invention can control the darkness and lightness of the color of the ink depending on the amount of pigment contained, and the pigment can be controlled within a range of 10 to 15 wt. % depending on the required color.

The water-based ink comprising a composition having the ratio as described above and a preparation method thereof are as follows.

It comprises a blending step (S21) of blending the dispersing resin, water, the dispersant, the antifoaming agent, the pigment, and wax, a dispersing step (S22) of dispersing the blend to prepare a base, and a mixing step (S23) of mixing the synthetic resin, the wetting agent, and ethanol into the base.

In this case, the dispersing resin blended in step (S21) plays a role of chemically assisting the dispersion of the pigment in step (S22), and may contain an epoxy ester resin, a vinyl modified epoxy resin, a high acid value alkyd resin, a vinyl modified resin, etc.

More specifically, the chemical dispersion in the step (S22) is achieved by the dispersing resin and the dispersant, and the physical dispersion is achieved by milling using a bead mill. Here, milling refers to uniformly mixing and kneading the components by heat and mechanical action.

In this case, the component ratio of the components excluding the dispersing resin is 30 to 40 wt. % of the synthetic resin, 17 to 46.8 wt. % of water, 10 to 20 wt. % of ethanol, 0.1 to 0.5 wt. % of the antifoaming agent, 0.1 to 0.5 wt. % of the wetting agent, 2 to 4 wt. % of the dispersant, 1 to 3 wt. % of the wax, and 10 to 15 wt. % of the pigment.

Hereinafter, the present invention will be described in more detail by way of examples. However, these examples are intended to exemplify the present invention, and the scope of the present invention is not limited by these examples.

### EXAMPLE 9

The dispersing resin, water, the dispersant, the antifoaming agent, the pigment and wax were first blended, and the blend was dispersed to prepare a base, and then, the synthetic resin, the wetting agent, and ethanol were mixed with the base to prepare a water-based ink. The component ratio of each component, excluding the dispersing resin, is as shown in the table below.

TABLE 13

| Component | wt. % |
|---|---|
| synthetic resin | 35 |
| water | 32.6 |
| ethanol | 15 |
| antifoaming agent | 0.2 |
| wetting agent | 0.2 |
| dispersant | 3 |
| wax | 2 |
| pigment | 12 |

### EXAMPLE 10

A water-based ink was prepared in the same manner as in Example 9. The component ratio of each component is as shown in the table below.

TABLE 14

| Component | wt. % |
|---|---|
| synthetic resin | 30 |
| water | 37.6 |
| ethanol | 15 |
| antifoaming agent | 0.2 |
| wetting agent | 0.2 |
| dispersant | 3 |
| wax | 2 |
| pigment | 12 |

### EXAMPLE 11

A water-based ink was prepared in the same manner as in Example 9. The component ratio of each component is as shown in the table below.

TABLE 15

| Component | wt. % |
|---|---|
| synthetic resin | 35 |
| water | 37.6 |
| ethanol | 10 |
| antifoaming agent | 0.2 |
| wetting agent | 0.2 |
| dispersant | 3 |
| wax | 2 |
| pigment | 12 |

### EXAMPLE 12

A water-based ink was prepared in the same manner as in Example 9. The component ratio of each component is as shown in the table below.

TABLE 16

| Component | wt. % |
|---|---|
| synthetic resin | 35 |
| water | 32.7 |
| ethanol | 15 |
| antifoaming agent | 0.1 |
| wetting agent | 0.2 |
| dispersant | 3 |
| wax | 2 |
| pigment | 12 |

### EXAMPLE 13

A water-based ink was prepared in the same manner as in Example 9. The component ratio of each component is as shown in the table below.

TABLE 17

| Component | wt. % |
|---|---|
| synthetic resin | 35 |
| water | 32.7 |
| ethanol | 15 |
| antifoaming agent | 0.2 |
| wetting agent | 0.1 |
| dispersant | 3 |
| wax | 2 |
| pigment | 12 |

### EXAMPLE 14

A water-based ink was prepared in the same manner as in Example 9. The component ratio of each component is as shown in the table below.

TABLE 18

| Component | wt. % |
|---|---|
| synthetic resin | 35 |
| water | 33.6 |
| ethanol | 15 |
| antifoaming agent | 0.2 |
| wetting agent | 0.2 |
| dispersant | 2 |
| wax | 2 |
| pigment | 12 |

### EXAMPLE 15

A water-based ink was prepared in the same manner as in Example 9. The component ratio of each component is as shown in the table below.

TABLE 19

| Component | wt. % |
|---|---|
| synthetic resin | 35 |
| water | 33.6 |
| ethanol | 15 |
| antifoaming agent | 0.2 |
| wetting agent | 0.2 |
| dispersant | 3 |
| wax | 1 |
| pigment | 12 |

### EXAMPLE 16

A water-based ink was prepared in the same manner as in Example 9. The component ratio of each component is as shown in the table below.

TABLE 20

| Component | wt. % |
|---|---|
| synthetic resin | 35 |
| water | 34.6 |
| ethanol | 15 |
| antifoaming agent | 0.2 |
| wetting agent | 0.2 |
| dispersant | 3 |
| wax | 2 |
| pigment | 10 |

### COMPARATIVE EXAMPLE 2

An ink was prepared by mixing a vinyl resin, a urethane resin, a pigment, and toluene. The component ratio of each component is as shown in the table below.

TABLE 21

| Component | wt. % |
|---|---|
| vinyl resin | 5 |
| urethane resin | 35 |
| pigment | 25 |
| toluene | 35 |

### EXPERIMENTAL EXAMPLE 4: RESIDUAL SOLVENT DETECTION TEST

The inks of Examples 9 to 16 and Comparative Example 2 were used to print on PVC film and the presence or absence of residual solvent was confirmed.

TABLE 22

| | Example | Example | Example | Example | Example | Example | Example | Example | Comparative |
|---|---|---|---|---|---|---|---|---|---|
| | 1 | 2 | 3 | 4 | 5 | 6 | 7 | 8 | Example 1 |
| Residual | not | not | not | not | not | not | not | not | detected |
| solvent | detected | detected | detected | detected | detected | detected | detected | detected | |

The test results showed that no residual solvent remained when printing with the water-based inks of Examples 9 to 16. The ink of Comparative Example 2 was found to leave residual solvent.

### EXPERIMENTAL EXAMPLE 5: DISSOLUTION TEST OF PVC FILM

Using the inks of Examples 9 to 16 and Comparative Example 2, printing was performed on a PVC film having a thickness of 0.04 mm, and the thickness of the PVC film printing area was measured to confirm the extent to which the ink dissolved the PVC film.

TABLE 23

| | Example | Example | Example | Example | Example | Example | Example | Example | Comparative |
|---|---|---|---|---|---|---|---|---|---|
| | 1 | 2 | 3 | 4 | 5 | 6 | 7 | 8 | Example 1 |
| Thickness of | 0.04 | 0.04 | 0.04 | 0.04 | 0.04 | 0.04 | 0.04 | 0.04 | 0.032 |
| PVC film | | | | | | | | | |
| printing area | | | | | | | | | |
| (mm) | | | | | | | | | |

The test results showed that when printed with the water-based inks of Examples 9 to 16, the PVC film printing area did not dissolve and thus the thickness was maintained. The ink of Comparative Example 2 was found to be printed while dissolving the PVC film, as evidenced by the reduction in the thickness of the PVC film printing area. As shown in Experimental Examples 4 and 5 above, it can be seen that in the case of ink containing a strong solvent such as toluene, it dissolves the PVC film and is printed, and residual solvent remains after printing. As such, the water-based ink of the present invention is printed without dissolving the PVC film, and leaves no residual solvent after printing, thereby resolving environmental and safety issues caused by an oil-based ink containing a strong solvent, which is a hazardous chemical substance, and thus is a useful ink that can replace the oil-based ink containing a strong solvent.

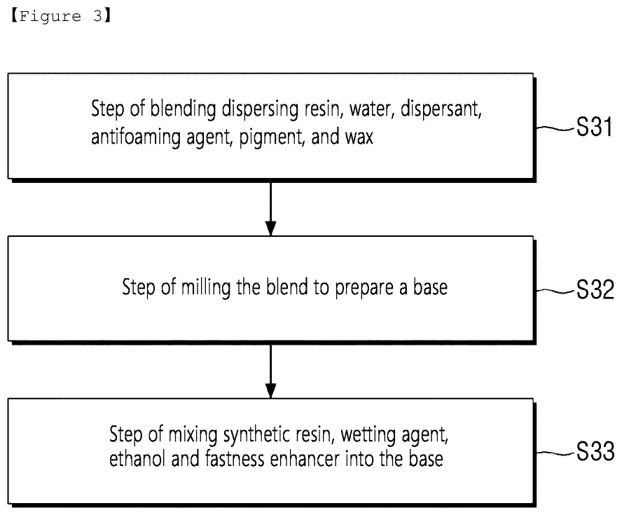

FIG. 3 is a flow chart illustrating a method for preparing water-based ink for textiles according to an embodiment of the present invention.

The present invention relates to a water-based ink for textiles and a preparation method thereof. It comprises a blending step, a dispersion step, and a mixing step. The water-based ink comprises a composition composed of an aqueous urethane, an aqueous acrylic, water, ethanol, an antifoaming agent, a wetting agent, a dispersant, wax, a pigment, and a fastness enhancer and may further comprise a dispersing resin.

The aqueous urethane is a component that maintains adhesiveness when printed on a fabric, and in a preferred embodiment of the present invention, it is contained in a component ratio of 5 to 20 wt. %.

The aqueous acrylic plays a role in allowing the ink to adhere to the fabric, and may contain an acrylic monomer such as acrylic acid or methyl methacrylate. In a preferred embodiment of the present invention, the aqueous acrylic is contained in a component ratio of 25 to 30 wt. %.

Water is used as a solvent for other components, and can be used by appropriately adjusting the component ratio within the range of 17 to 36.7 wt. %.

Ethanol is added to achieve quick drying properties, which is characteristic of ink. The ethanol is used as a solvent in ink, and unlike conventional solvents such as ethyl acetate and toluene, it is not a toxic substance and it has the advantage of not remaining on the fabric and volatilizing as it dries during the printing process. In a preferred embodiment of the present invention, the ethanol is contained in a component ratio of 10 to 20 wt. %.

The antifoaming agent prevents the formation of bubbles due to water during the dispersion process described later, thereby enabling smooth dispersion. In addition, the antifoaming agent prevents bubbles from appearing in the printed matter, thereby enabling accurate printing. In a preferred embodiment of the present invention, the antifoaming agent is contained in a component ratio of 0.1 to 0.5 wt. %.

The wetting agent plays a role in preventing re-aggregation of pigment and helping accurate printing. In a preferred embodiment of the present invention, the wetting agent is contained in a component ratio of 0.1 to 0.5 wt. %.

The dispersant chemically disperses the pigment, and thus plays a role in preventing aggregation of the pigment and maintaining dispersibility. In a preferred embodiment of the present invention, the dispersant is contained in a component ratio of 2 to 4 wt. %.

Wax plays a role in improving the frictional slipperiness of the printed surface when printed. In a preferred embodiment of the present invention, the wax contains polyethylene and is contained in a component ratio of 1 to 3 wt. %.

The pigment is a component that performs the coloring role of the water-based ink, and any pigment commonly used in the art can be used. Specifically, inorganic pigments such as carbon black and metal oxides and organic pigments such as azo pigments, diazo pigments, phthalocyanine pigments, perylene pigments, perinone pigments, thioindigo pigments, anthraquinone pigments, and quinophthalone pigments can be used. In a preferred embodiment of the present invention, a pigment having high light resistance is used as the pigment, and more specifically, it is preferred to use a pigment having a light resistance of grade 7 or higher.

The water-based ink according to one embodiment of the present invention can control the darkness and lightness of the color of the ink depending on the amount of pigment contained, and the pigment can be controlled within a range of 10 to 15 wt. % depending on the required color.

The fastness enhancer plays a role in improving the washing fastness property and friction fastness property of the ink. The fastness enhancer may contain silane and alkyl groups, and in a preferred embodiment of the present invention, it is contained in a component ratio of 0.1 to 1 wt. %.

The water-based ink comprising a composition having the ratio as described above and a preparation method thereof are as follows.

It comprises a blending step (S31) of blending the dispersing resin, water, the dispersant, the antifoaming agent, the pigment, and wax, a dispersing step (S32) of dispersing the blend to prepare a base, and a mixing step (S33) of mixing the synthetic resin, the wetting agent, ethanol and the fastness enhancer into the base.

In this case, the dispersing resin blended in step (S31) plays a role of chemically assisting the dispersion of the pigment in step (S32), and may contain an epoxy ester resin, a vinyl modified epoxy resin, a high acid value alkyd resin, a vinyl modified resin, etc.

In addition, the synthetic resin is composed of aqueous urethane and aqueous acrylic, and the fastness property of the ink may differ depending on the ratio. For example, if the ratio of the synthetic resin is not appropriate, when a printout printed with the synthetic resin is immersed in water, the color may transfer.

More specifically, the chemical dispersion in the step (S32) is achieved by the dispersing resin and the dispersant, and the physical dispersion is achieved by milling using a bead mill. Here, milling refers to uniformly mixing and kneading the components by heat and mechanical action.

In this case, the component ratio of the components excluding the dispersing resin is 15 to 20 wt. % of the aqueous urethane, 25 to 30 wt. % of the aqueous acrylic, 17 to 36.7% of water, 10 to 20 wt. % of ethanol, 0.1 to 0.5 wt. % of the antifoaming agent, 0.1 to 0.5 wt. % of the wetting agent, 2 to 4 wt. % of the dispersant, 1 to 3 wt. % of the wax, 10 to 15 wt. % of the pigment, and 0.1 to 1 wt. % of the fastness enhancer.

Hereinafter, the present invention will be described in more detail by way of examples. However, these examples are intended to exemplify the present invention, and the scope of the present invention is not limited by these examples.

### EXAMPLE 17

The dispersing resin, water, the dispersant, the antifoaming agent, the pigment and wax were first blended, and the blend was dispersed to prepare a base, and then, the synthetic resin, the wetting agent, ethanol and the fastness enhancer were mixed with the base to prepare a water-based ink. In this case, the synthetic resin is composed of aqueous urethane and aqueous acrylic, and the component ratio of each component, excluding the dispersing resin, is as shown in the table below.

TABLE 24

| Component | wt. % |
|---|---|
| aqueous urethane | 17 |
| aqueous acrylic | 27 |
| water | 23 |
| ethanol | 15 |
| antifoaming agent | 0.2 |
| wetting agent | 0.2 |
| dispersant | 3 |
| wax | 2 |
| pigment | 12 |
| fastness enhancer | 0.6 |

### EXAMPLE 18

A water-based ink for textiles was prepared in the same manner as in Example 17. The component ratio of each component is as shown in the table below.

TABLE 25

| Component | wt. % |
|---|---|
| aqueous urethane | 15 |
| aqueous acrylic | 27 |
| water | 25 |
| ethanol | 15 |
| antifoaming agent | 0.2 |
| wetting agent | 0.2 |
| dispersant | 3 |
| wax | 2 |
| pigment | 12 |
| fastness enhancer | 0.6 |

### EXAMPLE 19

A water-based ink for textiles was prepared in the same manner as in Example 17. The component ratio of each component is as shown in the table below.

TABLE 26

| Component | wt. % |
|---|---|
| aqueous urethane | 17 |
| aqueous acrylic | 25 |
| water | 25 |
| ethanol | 15 |
| antifoaming agent | 0.2 |
| wetting agent | 0.2 |
| dispersant | 3 |
| wax | 2 |
| pigment | 12 |
| fastness enhancer | 0.6 |

### EXAMPLE 20

A water-based ink for textiles was prepared in the same manner as in Example 17. The component ratio of each component is as shown in the table below.

TABLE 27

| Component | wt. % |
|---|---|
| aqueous urethane | 17 |
| aqueous acrylic | 27 |
| water | 28 |
| ethanol | 10 |
| antifoaming agent | 0.2 |
| wetting agent | 0.2 |
| dispersant | 3 |
| wax | 2 |
| pigment | 12 |
| fastness enhancer | 0.6 |

### EXAMPLE 21

A water-based ink for textiles was prepared in the same manner as in Example 17. The component ratio of each component is as shown in the table below.

TABLE 28

| Component | wt. % |
|---|---|
| aqueous urethane | 17 |
| aqueous acrylic | 27 |
| water | 23.1 |
| ethanol | 15 |
| antifoaming agent | 0.1 |
| wetting agent | 0.2 |
| dispersant | 3 |
| wax | 2 |
| pigment | 12 |
| fastness enhancer | 0.6 |

### EXAMPLE 22

A water-based ink for textiles was prepared in the same manner as in Example 17. The component ratio of each component is as shown in the table below.

TABLE 29

| Component | wt. % |
|---|---|
| aqueous urethane | 17 |
| aqueous acrylic | 27 |
| water | 23.1 |
| ethanol | 15 |
| antifoaming agent | 0.2 |
| wetting agent | 0.1 |
| dispersant | 3 |
| wax | 2 |
| pigment | 12 |
| fastness enhancer | 0.6 |

### EXAMPLE 21

A water-based ink for textiles was prepared in the same manner as in Example 17. The component ratio of each component is as shown in the table below.

TABLE 30

| Component | wt. % |
|---|---|
| aqueous urethane | 17 |
| aqueous acrylic | 27 |
| water | 24 |
| ethanol | 15 |
| antifoaming agent | 0.2 |
| wetting agent | 0.2 |
| dispersant | 2 |
| wax | 2 |
| pigment | 12 |
| fastness enhancer | 0.6 |

### EXAMPLE 24

A water-based ink for textiles was prepared in the same manner as in Example 17. The component ratio of each component is as shown in the table below.

TABLE 31

| Component | wt. % |
|---|---|
| aqueous urethane | 17 |
| aqueous acrylic | 27 |
| water | 24 |
| ethanol | 15 |
| antifoaming agent | 0.2 |
| wetting agent | 0.2 |
| dispersant | 3 |
| wax | 1 |
| pigment | 12 |
| fastness enhancer | 0.6 |

### EXAMPLE 25

A water-based ink for textiles was prepared in the same manner as in Example 17. The component ratio of each component is as shown in the table below.

TABLE 32

| Component | wt. % |
|---|---|
| aqueous urethane | 17 |
| aqueous acrylic | 27 |
| water | 25 |
| ethanol | 15 |
| antifoaming agent | 0.2 |
| wetting agent | 0.2 |
| dispersant | 3 |
| wax | 2 |
| pigment | 10 |
| fastness enhancer | 0.6 |

### EXAMPLE 26

A water-based ink for textiles was prepared in the same manner as in Example 17. The component ratio of each component is as shown in the table below.

TABLE 33

| Component | wt. % |
|---|---|
| aqueous urethane | 17 |
| aqueous acrylic | 27 |
| water | 23.5 |
| ethanol | 15 |
| antifoaming agent | 0.2 |
| wetting agent | 0.2 |
| dispersant | 3 |
| wax | 2 |
| pigment | 12 |
| fastness enhancer | 0.1 |

### COMPARATIVE EXAMPLE 3

An ink was prepared by mixing a vinyl resin, a urethane resin, a pigment, and ethanol. The component ratio of each component is as shown in the table below.

TABLE 34

| Component | wt. % |
|---|---|
| vinyl resin | 5 |
| urethane resin | 35 |
| pigment | 25 |
| ethanol | 35 |

### EXPERIMENTAL EXAMPLE 6: EVALUATION OF FASTNESS PROPERTY

The cartridge of industrial printer VJ-1924 (MUTOH company) equipped with Epson head DX7 was filled with inks of Examples 1 to 10 and Comparative Example 1, respectively, and printing was performed. The printing conditions were monochrome, 720×720 resolution, 4 pass printing, and the fabrics were printed on a Roll-type CM40's plain cotton fabric, then hot-pressed at 180 °C for 3 minutes, and then the dyed fabrics were cut to meet the evaluation standards and the fastness property was evaluated. For the manufactured dyed fabrics, an experiment was conducted according to KSK ISO 105-X06: 2014 (A1S method). The degree of discoloration, fading, and contamination was assessed using the standard gray color chart and graded from grade 1 to grade 5. Grade 1 indicates the greatest degree of fading, and the closer it is to grade 5, the less fading there is.

In addition, the manufactured dyed fabrics were evaluated according to KSK ISO 105-X12: 2016 (Crockmeter method), and the degree of contamination was determined using a standard gray color chart and indicated from grade 1 to 5, with grade 5 being the best.

TABLE 35

| | | Washing fastness property | | | Friction fastness property | | | |
|---|---|---|---|---|---|---|---|---|
| | Light | | Contam- | Contam- | Warp | Warp | Filling | Filling |
| | fastness | Discoloration | ination: | ination: | yarn | yarn | yarn | yarn |
| | property | and fading | wool | cotton | (dry) | (wet) | (dry) | (wet) |
| Example 1 | 4 | 4-5 | 4 | 4-5 | 3-4 | 3 | 3-4 | 3 |
| Example 2 | 4 | 4-5 | 4 | 4-5 | 3-4 | 3 | 3-4 | 3 |
| Example 3 | 4 or | 4-5 | 4 | 4-5 | 3-4 | 3 | 3-4 | 3 |
| | more | | | | | | | |
| Example 4 | 4 | 4-5 | 4 | 4-5 | 3-4 | 3 | 3-4 | 3 |
| Example 5 | 4 | 4-5 | 4 | 4-5 | 3-4 | 3 | 3-4 | 3 |
| Example 6 | 4 or | 4-5 | 4 | 4-5 | 3-4 | 3 | 3-4 | 3 |
| | more | | | | | | | |
| Example 7 | 4 | 4-5 | 4 | 4-5 | 3-4 | 3 | 3-4 | 3 |
| Example 8 | 4 | 4-5 | 4 | 4-5 | 3-4 | 3 | 3-4 | 3 |
| Example 9 | 4 | 4-5 | 4 | 4-5 | 3-4 | 3 | 3-4 | 3 |
| Example 10 | 4 | 4-5 | 4 | 4-5 | 3-4 | 3 | 3-4 | 3 |
| Comparative | 4 or | 4-5 | 4 | 4-5 | 3-4 | 3 | 3-5 | 3 |
| Example 1 | more | | | | | | | |

As a result, as can be seen in Table 35, the inks of Examples 17 to 26 according to the present invention showed a trend in which light fastness property, washing fastness property, and friction fastness property are equivalent compared to the ink of Comparative Example 3 manufactured with a conventional ink composition. Therefore, the water-based ink for textiles according to the present invention can be expected to have excellent fastness properties and stability, and is a useful ink that can replace oil-based ink.

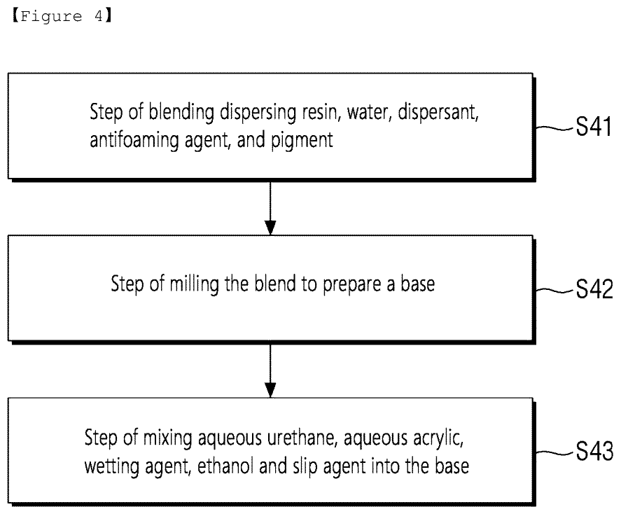

FIG. 4 is a flow chart illustrating a method for preparing water-based ink for shrink film according to an embodiment of the present invention.

The present invention relates to a water-based ink for shrink film and a preparation method thereof. The preparation method comprises a blending step, a dispersion step, and a mixing step. The water-based ink comprises a composition composed of an aqueous urethane, an aqueous acrylic, water, ethanol, an antifoaming agent, a wetting agent, a dispersant, a pigment, and a slip agent and may further comprise a dispersing resin.

The aqueous urethane is a component that maintains adhesiveness when printed on a film, and in a preferred embodiment of the present invention, it is contained in a component ratio of 10 to 15 wt. %.

The aqueous acrylic plays a role in allowing the ink to adhere to the film, and may contain an acrylic monomer such as acrylic acid or methyl methacrylate. In a preferred embodiment of the present invention, the aqueous acrylic is contained in a component ratio of 10 to 25 wt. %.

Meanwhile, the aqueous urethane and aqueous acrylic play a role in allowing the ink to adhere to the film. Therefore, if the proper ratio of aqueous urethane and aqueous acrylic changes, the adhesive strength decreases and problems may occur in the post-process of making a shrink label after printing.

Water is used as a solvent for other components, and can be used by appropriately adjusting the component ratio within the range of 19.5 to 47 wt. %.

Ethanol is added to achieve quick drying properties, which are characteristic of ink. The ethanol is used as a solvent in ink, and unlike conventional solvents such as toluene, it is not a toxic substance and it has the advantage of not remaining on the packaging and volatilizing as it dries during the printing process. In a preferred embodiment of the present invention, the ethanol is contained in a component ratio of 10 to 20 wt. %.

The antifoaming agent prevents the formation of bubbles due to water during the dispersion process described later, thereby enabling smooth dispersion. In addition, the antifoaming agent prevents bubbles from appearing in the printed matter, thereby enabling accurate printing. In a preferred embodiment of the present invention, the antifoaming agent is contained in a component ratio of 0.1 to 0.5 wt. %.

The wetting agent plays a role in preventing re-aggregation of pigment and helping accurate printing. In a preferred embodiment of the present invention, the wetting agent is contained in a component ratio of 0.1 to 0.5 wt. %.

The dispersant disperses the pigment, and thus plays a role in preventing aggregation of the pigment and maintaining dispersibility. In a preferred embodiment of the present invention, the dispersant is contained in a component ratio of 2 to 4 wt. %.

The pigment is a component that performs the coloring role of the ink, and any pigment commonly used in the art can be used. Specifically, inorganic pigments such as carbon black and metal oxides and organic pigments such as azo pigments, diazo pigments, phthalocyanine pigments, perylene pigments, perinone pigments, thioindigo pigments, anthraquinone pigments, and quinophthalone pigments can be used. Aluminum can be used depending on the color of the ink.

The water-based ink for shrink film according to the present invention can control the darkness and lightness of the color of the ink depending on the amount of pigment contained, and the pigment can be controlled within a range of 10 to 15 wt. % depending on the required color.

The slip agent plays a role in reducing friction when the shrink film wraps the container. In a preferred embodiment of the present invention, the slip agent is a silicone slip agent and is contained in a component ratio of 0.1 to 0.5 wt. %.

The water-based ink for shrink film comprising a composition having the ratio as described above and a preparation method thereof are as follows.

It comprises a blending step (S41) of blending the dispersing resin, water, the dispersant, the antifoaming agent, and the pigment, a dispersing step (S42) of dispersing the blend to prepare a base, and a mixing step (S43) of mixing the aqueous urethane, the aqueous acrylic, the wetting agent, ethanol and the slip agent into the base.

In this case, the dispersing resin blended in step (S41) plays a role of chemically assisting the dispersion of the pigment in step (S42), and may contain an epoxy ester resin, a vinyl modified epoxy resin, a high acid value alkyd resin, a vinyl modified resin, etc.

More specifically, the chemical dispersion in the step (S42) is achieved by the dispersing resin and the dispersant, and the physical dispersion is achieved by milling using a bead mill. Here, milling refers to uniformly mixing and kneading the components by heat and mechanical action.

In this case, the component ratio of the components excluding the dispersing resin is 10 to 15 wt. % of the aqueous urethane, 10 to 25 wt. % of the aqueous acrylic, 19.5 to 47 wt. % of water, 10 to 20 wt. % of ethanol, 0.1 to 0.5 wt. % of the antifoaming agent, 0.1 to 0.5 wt. % of the wetting agent, 2 to 4 wt. % of the dispersant, 10 to 15 wt. % of the pigment, and 0.1 to 0.5 wt. % of the slip agent.

Hereinafter, the present invention will be described in more detail by way of examples. However, these examples are intended to exemplify the present invention, and the scope of the present invention is not limited by these examples.

### EXAMPLE 27

The dispersing resin, water, the dispersant, the antifoaming agent, and the pigment were first blended, and the blend was dispersed to prepare a base, and then, the aqueous urethane, the aqueous acrylic, the wetting agent, ethanol and the slip agent were mixed with the base to prepare a water-based ink. The component ratio of each component, excluding the dispersing resin, is as shown in the table below.

TABLE 36

| Component | wt. % |
|---|---|
| aqueous urethane | 12 |
| aqueous acrylic | 17 |
| water | 40 |
| ethanol | 15 |
| antifoaming agent | 0.3 |
| wetting agent | 0.3 |
| dispersant | 3 |
| pigment | 12 |
| slip agent | 0.4 |

### EXAMPLE 28

A water-based ink for shrink film was prepared in the same manner as in Example 27. The component ratio of each component is as shown in the table below.

TABLE 37

| Component | wt. % |
|---|---|
| aqueous urethane | 10 |
| aqueous acrylic | 17 |
| water | 42 |
| ethanol | 15 |
| antifoaming agent | 0.3 |
| wetting agent | 0.3 |
| dispersant | 3 |
| pigment | 12 |
| slip agent | 0.4 |

### EXAMPLE 29

A water-based ink for shrink film was prepared in the same manner as in Example 27. The component ratio of each component is as shown in the table below.

TABLE 38

| Component | wt. % |
|---|---|
| aqueous urethane | 12 |
| aqueous acrylic | 10 |
| water | 47 |
| ethanol | 15 |
| antifoaming agent | 0.3 |
| wetting agent | 0.3 |
| dispersant | 3 |
| pigment | 12 |
| slip agent | 0.4 |

### EXAMPLE 30

A water-based ink for shrink film was prepared in the same manner as in Example 27. The component ratio of each component is as shown in the table below.

TABLE 39

| Component | wt. % |
|---|---|
| aqueous urethane | 12 |
| aqueous acrylic | 17 |
| water | 45 |
| ethanol | 10 |
| antifoaming agent | 0.3 |
| wetting agent | 0.3 |
| dispersant | 3 |
| pigment | 12 |
| slip agent | 0.4 |

### EXAMPLE 31

A water-based ink for shrink film was prepared in the same manner as in Example 27. The component ratio of each component is as shown in the table below.

TABLE 40

| Component | wt. % |
|---|---|
| aqueous urethane | 12 |
| aqueous acrylic | 17 |
| water | 40.2 |
| ethanol | 15 |
| antifoaming agent | 0.1 |
| wetting agent | 0.3 |
| dispersant | 3 |
| pigment | 12 |
| slip agent | 0.4 |

### EXAMPLE 32

A water-based ink for shrink film was prepared in the same manner as in Example 27. The component ratio of each component is as shown in the table below.

TABLE 41

| Component | wt. % |
|---|---|
| aqueous urethane | 12 |
| aqueous acrylic | 17 |
| water | 40.2 |
| ethanol | 15 |
| antifoaming agent | 0.3 |
| wetting agent | 0.1 |
| dispersant | 3 |
| pigment | 12 |
| slip agent | 0.4 |

### EXAMPLE 33

A water-based ink for shrink film was prepared in the same manner as in Example 27. The component ratio of each component is as shown in the table below.

TABLE 42

| Component | wt. % |
|---|---|
| aqueous urethane | 12 |
| aqueous acrylic | 17 |
| water | 41 |
| ethanol | 15 |
| antifoaming agent | 0.3 |
| wetting agent | 0.3 |
| dispersant | 2 |
| pigment | 12 |
| slip agent | 0.4 |

### EXAMPLE 34

A water-based ink for shrink film was prepared in the same manner as in Example 27. The component ratio of each component is as shown in the table below.

TABLE 43

| Component | wt. % |
|---|---|
| aqueous urethane | 12 |
| aqueous acrylic | 17 |
| water | 42 |
| ethanol | 15 |
| antifoaming agent | 0.3 |
| wetting agent | 0.3 |
| dispersant | 3 |
| pigment | 10 |
| slip agent | 0.4 |

### EXAMPLE 35

A water-based ink for shrink film was prepared in the same manner as in Example 27. The component ratio of each component is as shown in the table below.

TABLE 44

| Component | wt. % |
|---|---|
| aqueous urethane | 12 |
| aqueous acrylic | 17 |
| water | 42.3 |
| ethanol | 15 |
| antifoaming agent | 0.3 |
| wetting agent | 0.3 |
| dispersant | 3 |
| pigment | 10 |
| slip agent | 0.1 |

### COMPARATIVE EXAMPLE 4

An ink was prepared by mixing a vinyl resin, a urethane resin, a pigment, and toluene. The component ratio of each component is as shown in the table below.

TABLE 45

| Component | wt. % |
|---|---|
| vinyl resin | 5 |
| urethane resin | 35 |
| pigment | 25 |
| toluene | 35 |

### EXPERIMENTAL EXAMPLE 7: DETECTION TEST FOR RESIDUAL SOLVENT

Using the inks of Examples 27 to 35 and Comparative Example 4, printing was performed on shrink film and the presence or absence of residual solvent was confirmed.

TABLE 50

| | Example | Example | Example | Example | Example | Example | Example | Example | Example | Comparative |
|---|---|---|---|---|---|---|---|---|---|---|
| | 1 | 2 | 3 | 4 | 5 | 6 | 7 | 8 | 9 | Example 1 |
| Residual | not | not | not | not | not | not | not | not | not | detected |
| solvent | detected | detected | detected | detected | detected | detected | detected | detected | detected | |

The test results showed that when printed with water-based inks for shrink film of Examples 27 to 35, no residual solvent remained. The ink of Comparative Example 1 was found to leave residual solvent.

### EXPERIMENTAL EXAMPLE 8: DISSOLUTION TEST OF SHRINK FILM

Using the inks of Examples 27 to 35 and Comparative Example 4, printing was performed on a PVC shrink film having a thickness of 0.04 mm, and the thickness of the shrink film printing area was measured to confirm the extent to which the ink dissolved the shrink film.

TABLE 51

| | Example | Example | Example | Example | Example | Example | Example | Example | Example | Comparative |
|---|---|---|---|---|---|---|---|---|---|---|
| | 1 | 2 | 3 | 4 | 5 | 6 | 7 | 8 | 9 | Example 1 |
| Thickness | 0.04 | 0.04 | 0.04 | 0.04 | 0.04 | 0.04 | 0.04 | 0.04 | 0.04 | 0.032 |
| of shrink | | | | | | | | | | |
| film | | | | | | | | | | |
| printing | | | | | | | | | | |
| area (mm) | | | | | | | | | | |

The test results showed that when printed with the water-based inks for shrink film of Examples 27 to 35, the shrink film printing area did not dissolve and thus the thickness was maintained. The ink of Comparative Example 4 was found to be printed while dissolving the shrink film, as evidenced by the reduction in the thickness of the shrink film printing area.

As shown in Experimental Examples 7 and 8 above, it can be seen that in the case of ink containing a strong solvent such as toluene, it dissolves the shrink film and is printed, and residual solvent remains after printing. As such, the water-based ink for shrink film of the present invention is printed without dissolving the shrink film, and leaves no residual solvent after printing, thereby resolving environmental and safety issues caused by an oil-based ink containing a strong solvent, and thus is a useful ink that can replace the oil-based ink containing a strong solvent.

Meanwhile, the embodiments of the present invention disclosed in this specification and drawings are only specific examples presented to easily explain the technical contents of the present invention and to help understand the present invention, and are not intended to limit the scope of the present invention. It will be apparent to those skilled in the art that other modified embodiments based on the technical idea of the present invention can be implemented in addition to the embodiments disclosed herein.

### INDUSTRIAL APPLICABILITY

The water-based ink of the present invention can be used for flexographic printing without dissolving PP film and without hazardous chemical substances, adheres to print media, and has high water resistance.

In addition, the water-based ink of the present invention can be used for gravure printing without dissolving PVC fabric and without hazardous chemical substances, and can be adhered to print media.

In addition, the present invention can provide a water-based ink for textiles that enables clear printing on textiles and has excellent fastness properties.

In addition, the water-based ink of the present invention can be gravure printed without dissolving shrink film and without hazardous chemical substances, and can be adhered to print media.

1. A water-based ink, comprising a synthetic resin, water, ethanol, an antifoaming agent, a wetting agent, a dispersant and a pigment.

2. The water-based ink according to claim 1, wherein the synthetic resin is aqueous urethane and aqueous acrylic,
comprises a composition having a ratio of 12.5 to 30 wt. % of the aqueous urethane, 5 to 10 wt. % of the aqueous acrylic, 20 to 37.5 wt. % of the water, 10 to 20 wt. % of the ethanol, 0.1 to 0.5 wt. % of the antifoaming agent, 0.1 to 0.5 wt. % of the wetting agent, 2 to 4 wt. % of the dispersant, and 10 to 15 wt. % of the pigment, and
is for flexographic printing on the surface of PP film.

3. The water-based ink according to claim 1, further comprising wax,
comprises a composition having a ratio of 30 to 40 wt. % of the synthetic resin, 17 to 46.8 wt. % of water, 10 to 20 wt. % of ethanol, 0.1 to 0.5 wt. % of the antifoaming agent, 0.1 to 0.5 wt. % of the wetting agent, 2 to 4 wt. % of the dispersant, 1 to 3 wt. % of the wax, and 10 to 15 wt. % of the pigment,
wherein the synthetic resin contains aqueous epoxy, aqueous acrylic, and aqueous urethane, and
is for gravure printing on the surface of PVC.

4. The water-based ink according to claim 1, further comprising wax and a fastness enhancer,
wherein the synthetic resin is aqueous urethane and aqueous acrylic,
comprises a composition having a ratio of 15 to 20 wt. % of the aqueous urethane, 25 to 30 wt. % of the aqueous acrylic, 17 to 36.7% of water, 10 to 20 wt. % of ethanol, 0.1 to 0.5 wt. % of the antifoaming agent, 0.1 to 0.5 wt. % of the wetting agent, 2 to 4 wt. % of the dispersant, 1 to 3 wt. % of the wax, 10 to 15 wt. % of the pigment, and 0.1 to 1 wt. % of the fastness enhancer, and
is for textiles.

5. The water-based ink according to claim 1, further comprising a slip agent,
wherein the synthetic resin is aqueous urethane and aqueous acrylic,
comprises a composition having a ratio of 10 to 15 wt. % of the aqueous urethane, 10 to 25 wt. % of the aqueous acrylic, 19.5 to 47 wt. % of water, 10 to 20 wt. % of ethanol, 0.1 to 0.5 wt. % of the antifoaming agent, 0.1 to 0.5 wt. % of the wetting agent, 2 to 4 wt. % of the dispersant, 10 to 15 wt. % of the pigment, and 0.1 to 0.5 wt. % of the slip agent, and
is for shrink film.

6. The water-based ink according to claim 1, wherein the pigment contains at least one of an inorganic pigment and an organic pigment.

7. The water-based ink according to claim 3, wherein the wax contains polyethylene.

8. The water-based ink according to claim 4, wherein the fastness enhancer contains at least one of a silane and an alkyl group.

9. The water-based ink according to claim 5, wherein the pigment contains aluminum.

10. The water-based ink according to claim 4, wherein the wax contains polyethylene.
